(19) United States
(12) Patent Application Publication
(10) Pub. No.: US 2006/0257181 A1
(43) Pub. Date: Nov. 16, 2006

(54) Sheet feeding unit for continuous form recording medium

(75) Inventor: Masatoshi Takano, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/430,997

(22) Filed: May 10, 2006

(30) Foreign Application Priority Data
May 11, 2005 (JP) 2005-137992

(51) Int. Cl. G03G 15/00

(52) U.S. Cl. 399/384

(57) ABSTRACT

A feeding unit for a continuous form recording medium, having a feed roller, a drive motor, a first transmitting system, a second transmitting system, is provided. The first transmitting system is adapted to transmit rotating force from the drive motor to the feed roller so that the feed roller is rotated in a normal feeding direction to carry the continuous form recording medium and to allow the feed roller to be rotated in the normal feeding direction by external force. The second transmitting system is adapted to transmit the rotating force from the drive motor to the feed roller so that the feed roller is rotated in a reverse feeding direction. The switching system transmits stalling torque of the drive motor to the feed roller associated by the second transmitting system before and after the continuous form recording medium is processed through an image forming operation.

### BACKGROUND OF THE INVENTION

The present invention relates to an image forming apparatus capable of forming an image on a continuous form recording sheet in an electrophotographic method, and particularly to a sheet feeding unit for a continuous form recording sheet, which is used in the image forming apparatus, capable of restricting a movement of the recording sheet in a standby period of the image forming apparatus.

Conventionally, an image forming apparatus employing an electrophotographic technology, such as a copier and a laser beam printer, is known. Such an image forming apparatus is adapted to form a latent image corresponding to image data on a surface of a photoconductive drum by laser beam or the like. When toner is adhered to the latent image, a toner image is formed on the surface of the photoconductive drum. The toner image is then in a developing unit transferred to a surface of a recording sheet that has been introduced via a sheet feed roller of a sheet feeding unit, and is permanently fixed on the recording sheet in a fixing unit.

This type of image forming apparatus includes an apparatus that uses roll sheet paper as a recording medium. In such an image forming apparatus, feeding speed at the sheet feeding unit is configured to be slower than a feeding speed at the developing unit, so that the roll sheet paper should be pulled toward the developing unit and may not be loosened in between the two units. Once a front end of the roll sheet paper is reached to the developing unit, the roll sheet paper is carried (pulled) at the feeding speed of the developing unit. A portion of the sheet feed roller of the sheet feeding unit to which driving force is applied is provided with a mechanism to have the drive source to run idly, such as a one-way clutch and the like, so that the sheet feed roller can be rotated by friction with the roll sheet paper, which is pulled from the sheet feeding unit toward the developing unit when the pull force is applied to the sheet feed roller. However, with this configuration, the roll sheet paper can be also manually arbitrarily pulled toward a discharge portion of the apparatus, wherein the roll sheet paper with the formed image is discharged. Therefore, the roll sheet paper may be displaced from a correct position with respect to the image forming apparatus, and when image forming is resumed in the same image forming apparatus, the image may not be formed in a correct position of the roll sheet paper.

In Japanese Patent Provisional Publication No. HEI5-142893, an electrophotographic printer having a tractor belt to feed fan-folded sheet paper with feed holes at both sides is disclosed, and the tractor belt is provided with a plurality of projections that engage with the feed holes. The electrophotographic printer is provided with an electromagnetic clutch as a locking mechanism to lock the sheet paper so that the sheet paper is restricted in moving in the electrophotographic printer and an image can be formed on a correct position of the sheet paper when image forming operation is resumed.

Such a locking mechanism with an electromagnetic clutch may be also employed in the image forming apparatus using the roll sheet paper, however, the electromagnetic clutch requires power source as well as a controlling unit, which eventually require additional space in the image forming apparatus. Further, for the above-described locking mechanism with the tractor belt, the sheet paper requires to have feed holes, which are generally not provided to the roll sheet paper.

### SUMMARY OF THE INVENTION

In view of the foregoing shortcomings, the present invention is advantageous in that a feeding unit of a continuous form recording medium is provided, and particularly to a feeding unit with a mechanism having a one-way clutch to prevent the recording medium from loosening and with a locking mechanism that restricts a movement of the recording medium in between image forming operations.

According to an aspect of the invention, there is provided a feeding unit for a continuous form recording medium, having a feed roller, which is adapted to be rotated by one of rotating force and external force to carry the continuous form recording medium, a drive motor, which is adapted to apply the rotating force to the feed roller, a first transmitting system, which is adapted to selectively transmit the rotating force from the drive motor to the feed roller according to the force to rotate the feed roller, a second transmitting system, which is adapted to compulsorily transmit the rotating force from the drive motor to the feed roller, and a switching system, which is adapted to switch from one of the first transmitting system and the second transmitting system to the other to be used to transmit the rotating force from the drive motor to the feed roller. The first transmitting system is adapted to transmit the rotating force from the drive motor to the feed roller so that the feed roller is rotated in a normal feeding direction to carry the continuous form recording medium and to allow the feed roller to be rotated in the normal feeding direction by the external force. The second transmitting system is adapted to transmit the rotating force from the drive motor to the feed roller so that the feed roller is rotated in a reverse feeding direction. The switching system transmits stalling torque of the drive motor to the feed roller associated by the second transmitting system before and after the continuous form recording medium is processed through an image forming operation.

Optionally, the feeding unit may include a first gear, which is fixed to a rotating shaft of the feed roller, and a second gear, which is adapted to rotate about the rotating shaft of the feed roller via a one-way clutch mechanism transmitting the rotating force from the drive motor to the feed roller and allowing the rotating shaft of the feed roller to rotate independently from the rotation of the feed roller when the feed roller is rotated by the external force. The second transmitting system may transmit the rotating force from the drive motor to the feed roller by the first gear. The first transmitting system may transmit the rotating force from the drive motor to the feed roller via the second gear.

Optionally, the switching system may include a main transmitting gear, a first intermediate gear, and a second intermediate gear. The first intermediate gear and the second intermediate gear may be respectively engaged with the main transmitting gear. The main transmitting gear may be applied the rotating force by the drive motor. The first gear may be transmitted the rotating force from the drive motor via the first intermediate gear. The second gear may be transmitted the rotating force from the drive motor via the second intermediate gear.

Optionally, the main transmitting gear, the first intermediate gear, and the second intermediate gear may be respectively rotatably supported by a supporting member. The supporting member may be capable of rotating for a predetermined amount about a rotation axis of the main transmitting gear. The first intermediate gear and the second intermediate gear may be adapted to be respectively shifted for a predetermined amount along a circumference of the main transmitting gear about the rotation axis of the main transmitting gear. The switching system may be allowed to be in one of a position to have the first intermediate gear engaged with the first gear and a position to have the second intermediate gear engaged with the second gear.

Optionally, the first intermediate gear and the second intermediate gear may be adapted to be shifted along the circumference of the main transmitting gear by rotating force of the main transmitting gear.

Optionally, the first intermediate gear and the second intermediate gear may be adapted to be shifted along the circumference of the main transmitting gear by rotation of the supporting member caused by an attracting member being arranged in a predetermined position of the supporting member.

Optionally, the second transmitting system may include a first combination gear and a second combination gear. The first combination gear may be operated in combination with the drive motor. The second combination gear may be engaged with the first combination gear at all times and may be capable of engaging with a fixed gear, the fixed gear being fixed to the feed roller. The first transmitting system includes a first indirect combination gear and a second indirect combination gear. The first indirect combination gear may be configured to rotate integrally with the first combination gear when the first combination gear is rotated for a predetermined amount in a direction corresponding to the normal feeding direction of the feed roller. The second indirect combination gear may be engaged with the first indirect combination gear and the fixed gear at all times. The first indirect combination gear may be allowed to be rotated independently from the first combination gear in the direction corresponding to the normal feeding direction of the feed roller by the external force.

Optionally, the switching system may include a supporting switch member rotatably supporting the first combination gear and the second combination gear. The supporting switch member may be adapted to rotate about an rotation axis of the first combination gear for a predetermined amount. The supporting switch member may be allowed to be in one of a position to have the second combination gear engaged with the fixed gear and a position to have the second combination gear released from the fixed gear by having the second combination gear to be shifted along a circumference of the first combination gear about the rotation axis of the first combination gear.

Optionally, the second combination gear may be shifted along the circumference of the first combination gear by rotating force of the first combination gear.

Optionally, the first combination gear and the first indirect combination gear located in adjacent to each other may be adapted to rotate about a common axis. Each of the first combination gear and the first indirect combination gear may be provided with an inner circumferential surface that encircles the common axis. A spring may coiled around the inner circumferential surface of the first combination gear and the inner circumferential surface of the first indirect combination gear. The spring may be arranged in an orientation so that the spring tightens the inner circumferential surface of the first combination gear and the inner circumferential surface of the first indirect combination gear when the first combination gear is rotated in the direction corresponding to the normal feeding direction of the feed roller.

Optionally, the fixed gear may be provided with a smaller diameter portion having a diameter and a greater diameter portion having a diameter that is greater than the diameter of the smaller diameter portion. The smaller diameter portion and the greater diameter portion may be arranged along a rotation axis of the fixed gear. The second indirect combination gear may be engaged with the smaller diameter portion and the second combination gear may be engaged with the greater diameter portion.

According to another aspect of the invention, there is provided an image forming apparatus, having a feeding unit, which is adapted to guide to carry a continuous form recording medium in a recording media transport path, and an image forming unit, through which the continuous form recording medium is carried and wherein an image is formed on the continuous form recording medium. A feeding speed of the continuous form recording medium at the feeding unit is adapted to be lower than a feeding speed of the continuous form recording medium at the image forming unit. The feeding unit includes a feed roller, which is adapted to be rotated by one of rotating force and external force to carry the continuous form recording medium, a drive motor, which is adapted to apply the rotating force to the feed roller, a first transmitting system, which is adapted to selectively transmit the rotating force from the drive motor to the feed roller according to the force to rotate the feed roller, a second transmitting system, which is adapted to compulsorily transmit the rotating force from the drive motor to the feed roller, and a switching system, which is adapted to switch from one of the first transmitting system and the second transmitting system to the other to be used to transmit the rotating force from the drive motor to the feed roller. The first transmitting system is adapted to transmit the rotating force from the drive motor to the feed roller so that the feed roller is rotated in a normal feeding direction to carry the continuous form recording medium and to allow the feed roller to be rotated in the normal feeding direction by the external force. The second transmitting system is adapted to transmit the rotating force from the drive motor to the feed roller so that the feed roller is rotated in a reverse feeding direction. The switching system transmits stalling torque of the drive motor to the feed roller associated by the second transmitting system before and after the image forming apparatus is in an image forming operation.

According to another aspect of the invention, there is provided a feeding unit for a continuous form recording medium, having a feed roller, which is adapted to be rotated by one of rotating force and external force to carry the continuous form recording medium, a drive motor, which is adapted to apply the rotating force to the feed roller, a first transmitting system, which is adapted to selectively transmit the rotating force from the drive motor to the feed roller according to the force to rotate the feed roller, a second transmitting system, which is adapted to compulsorily transmit the rotating force from the drive motor to the feed roller, and a switching system, which is adapted to switch from one of the first transmitting system and the second transmitting system to the other to be used to transmit the rotating force from the drive motor to the feed roller. The switching system uses the first transmitting system when the feed roller is rotated in a normal feeding direction to carry the continuous form recording medium and uses the second transmitting system when the feed roller is rotated in a reverse feeding direction. The feed roller is restricted from rotating by stalling torque of the drive motor before and after the continuous form recording medium is in an image forming operation.

Optionally, the first transmitting system may be adapted to transmit the rotating force from the drive motor to the feed roller so that the feed roller is rotated in the normal feeding direction to carry the continuous form recording medium and to allow the feed roller to be rotated in the normal feeding direction by the external force.

According to another aspect of the invention, there is provided an image forming apparatus, having a feeding unit, which is adapted to guide to carry a continuous form recording medium in a recording media transport path, and an image forming unit, through which the continuous form recording medium is carried and wherein an image is formed on the continuous form recording medium, is provided. A feeding speed of the continuous form recording medium at the feeding unit is adapted to be lower than a feeding speed of the continuous form recording medium at the image forming unit. The feeding unit includes a feed roller, which is adapted to be rotated by one of rotating force and external force to carry the continuous form recording medium, a drive motor, which is adapted to apply the rotating force to the feed roller, a first transmitting system, which is adapted to selectively transmit the rotating force from the drive motor to the feed roller according to the force to rotate the feed roller, a second transmitting system, which is adapted to compulsorily transmit the rotating force from the drive motor to the feed roller; and a switching system, which is adapted to switch from one of the first transmitting system and the second transmitting system to the other to be used to transmit the rotating force from the drive motor to the feed roller. The switching system uses the first transmitting system when the feed roller is rotated in a normal feeding direction to carry the continuous form recording medium and uses the second transmitting system when the feed roller is rotated in a reverse feeding direction. The feed roller is restricted from rotating by stalling torque of the drive motor before and after the image forming apparatus is in an image forming operation.

### BRIEF DESCRIPTION OF THE ACCOMPANYING DRAWINGS

FIG. 1 is a diagram to illustrate a general configuration of an image forming apparatus according to a first embodiment of the present invention.

FIG. 2 is a diagram to illustrate a drive direction switching system according to the embodiment of the present invention.

FIG. 3 is an enlarged perspective view of the drive direction switching system according to an embodiment of the present invention.

FIG. 4 is an enlarged perspective view of the drive direction switching system taken from an opposite side of the side shown in FIG. 2 according to the embodiment of the present invention.

FIG. 5 is a diagram to illustrate a movement of the drive direction switching system according to the embodiment of the present invention.

FIG. 6 is a diagram to illustrate another movement of the drive direction switching system according to the embodiment of the present invention.

FIG. 7 is an enlarged perspective view of a drive direction switching system according to a second embodiment of the present invention.

FIG. 8 is an enlarged perspective view of the drive direction switching system taken from an opposite side of the side shown in FIG. 7 according to the second embodiment of the present invention.

FIG. 9 is a cross-sectional partial view of the drive direction switching system according to the second embodiment of the present invention.

FIG. 10 is an enlarged perspective view of the drive direction switching system in a sheet feeding operation according to the second embodiment of the present invention.

FIG. 11 is an enlarged perspective view of a drive direction switching system in a sheet feeding operation according to a variation of the second embodiment of the present invention.

### DETAILED DESCRIPTION OF THE EMBODIMENTS

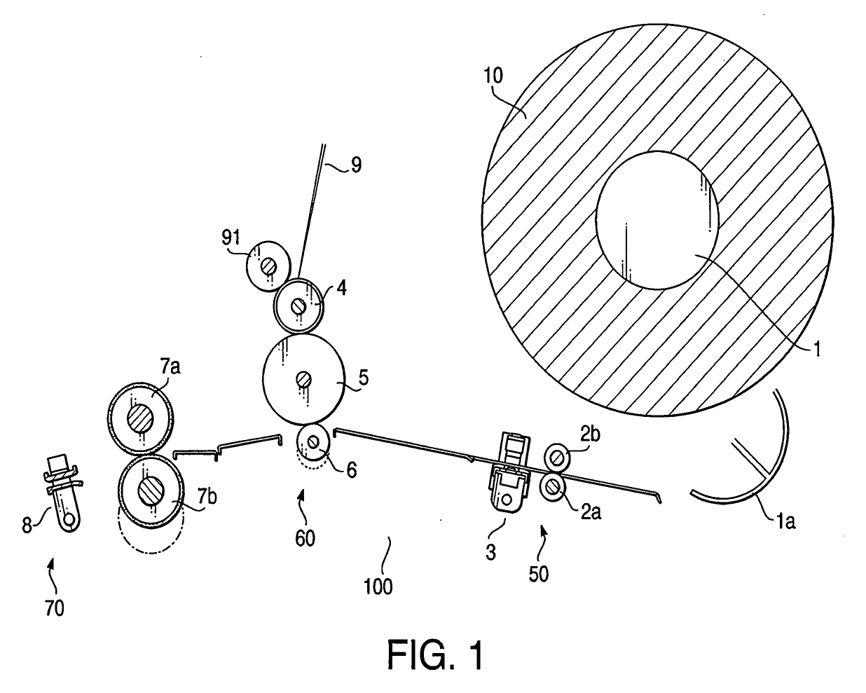

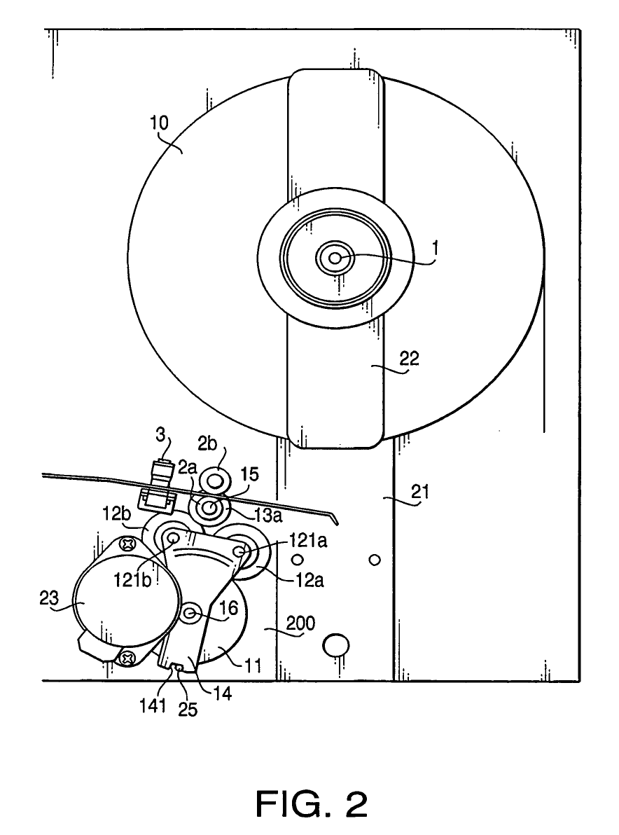

Referring to the accompanying drawings, a feeding unit with a drive direction switching system for a continuous form recording medium according to an embodiment of the present invention will be described in detail. FIG. 1 is a diagram to illustrate a general configuration of the image forming apparatus 100 according to a first embodiment of the present invention. FIG. 2 is a diagram to illustrate a drive direction switching system according to the embodiment of the present invention. The image forming apparatus 100, which is often used as an output device for a computer, is adapted to form an image on a continuous form recording sheet (hereinafter referred to as a recording sheet) 10 in an electrophotographic method by exposing a surface of a photoconductive drum 4 to a laser beam modulated according to information (image data) inputted by a user.

As shown in FIGS. 1 and 2, the image forming apparatus 100 is provided with a feeding unit 50 including a core roll 1, around which the recording sheet 10 is rolled, a drive direction switching system 200, feed rollers 2a, 2b, and a fed sheet sensor 3, a drive motor 23 being a pulse motor. The image forming apparatus 100 is further provided with a developing unit (an image forming unit) 60 including the photoconductive drum 4, an intermediate transfer roller 5, a secondary transfer roller 6, and an optical unit for outputting the laser beam 9, and with a discharge unit 70 including fixing rollers 7a, 7b, and a discharged sheet sensor 8.

The recording sheet 10 is forwarded in the image forming apparatus 100 from the feeding unit 50 to the discharge unit 70 via the developing unit 60. When image forming (i.e., printing) is completed, a front end portion of the recording sheet 10 on which the image is formed is discharged from the image forming apparatus 100 and is cut off with a cutter and the like automatically or manually. In this configuration, a newly created front end of the remaining recording sheet 10 is positioned in the discharge unit 70. When a new printing operation is conducted with the front end of the recording sheet in the discharge unit 70 (a normal print operation), a front end portion of the recording sheet 10 between the developing unit 60 and the discharge unit 70 is not provided with a new image, thus the front end portion is wasted. In consideration of this drawback, the image forming apparatus 100 may be configured to rewind the recording sheet 10 so that the front end is brought back to the feeding unit 50 before a new printing operation is started (a reverse-and-print operation).

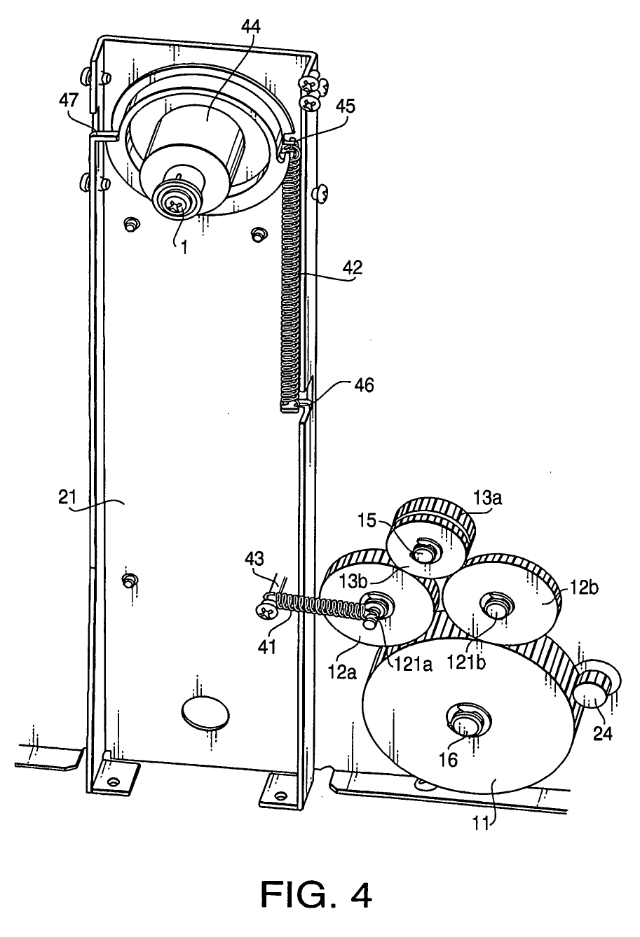

As shown in FIG. 2, the recording sheet 10 is rolled around a core roll 1 that is rotatably supported by a roll support 21. The roll support 21 is fixed to a body of the image forming apparatus 100 and is arranged at a back of the drive direction switching system 200 in FIG. 2. The core roll 1 is supported between the roll support 21 and a holding plate 22. The holding plate 22 is adapted to be removable, and when the recording sheet 10 is exchanged, the recording sheet 10 is removed from and attached to the roll support 21 in a direction perpendicular to the roll support 21. The holding plate 22 is configured to press a side surface (i.e., a circular area composed of a side of the rolled sheet) of the recording sheet 10 in a predetermined manner, and thereby hold the recording sheet 10. A front end portion of the recording sheet 10 is unwound and directed to the feed rollers 2a, 2b by a guide 1a that extends in an axial direction of the core roll 1. The core roll 1 is adapted to rotate in a clockwise direction in FIG. 1 (hereinafter referred to as a normal direction) when the feed rollers 2a, 2b rotate to forward the recording sheet 10 and thereby pull the same. When a reverse-and-print operation is conducted, the feed rollers 2a, 2b rotate in respective reverse directions to reverse the recording sheet 10 after a previous printing operation is completed or before a new printing operation is started. The core roll 1 includes a torque limiter (not shown) that prevents overload on the core roll 1 and a pulley 44 (see FIG. 4) that rotates the core roll 1 in a counterclockwise direction in FIG. 1 (hereinafter referred to as a reverse direction) so that the recording sheet 10 is tensioned between the feed rollers 2a, 2b and the core roll 1. As the recording sheet 10 is pressed in between the roll support 21 and the holding plate 22, the recording sheet 10 is prevented from being displaced in the axial direction, so that the recording sheet 10 can be securely rolled to the core roll 1.

The feed roller 2a is rotated by rotating drive force from the drive motor 23 that is transmitted via the drive direction switching system 200. When the recording sheet 10 is fed in a direction from the feeding unit 50 toward the discharge unit 70 (i.e., a normal sheet feeding direction), the feed roller 2a rotates in a normal feeding direction (i.e., the counterclockwise direction in FIG. 1), and when the recording sheet 10 is reversed (i.e., in a reverse sheet feeding direction), the feed roller 2a rotates in a reverse feeding direction (i.e., the clockwise direction in FIG. 1). In a reverse-and-print operation, the front end of the recording sheet 10 that is positioned in a vicinity to the discharge unit 70 is brought back to a position between the feed roller 2a and the fed sheet sensor 3. A number of pulses of the drive motor 23 to be activated for the reverse-and-print operation may be fixed in advance so that a length of the recording sheet 10 to be reversed can be fixed. Further, an rotating shaft of the feed roller 2a is configured to correspond to a rotating shaft of a gear 13b, which is one of gears included in the drive direction switching system 200. The feed roller 2b is rotated about an axis independently from the drive direction switching system 200, according to the rotation of the feed roller 2a, in an opposite direction from the rotating direction of the feed roller 2a. It should be noted that the feed roller 2b is mutually abut at a predetermined nip pressure with the feed roller 2a, so that the recording sheet 10 is effectively carried between the two feed rollers 2a, 2b.

When a predetermined position of the recording sheet 10 such as the front end thereof passes by the fed sheet sensor 3, the fed sheet sensor 3 detects the same, and a timing of the laser beam 9 to be emitted is calculated based on the detected predetermined position of the recording sheet 10. It should be noted that with this configuration the image can be formed on a predetermined position with respect to the recording sheet 10.

The photoconductive drum 4 is adapted to rotate in the counterclockwise direction in FIG. 1. The photoconductive drum 4 is applied voltage and uniformly charged to a predetermined level, which is approximately +700 V, by a charger (not shown). The photoconductive drum 4 is thereafter rotated and exposed to the laser beam 9 that scans the surface of the photoconductive drum 4 in parallel with a rotation axis of the photoconductive drum 4 (i.e., a main scanning direction) according to the image data, and a latent image is formed on the surface of the photoconductive drum 4, as regions where the latent image is formed gains a lower potential, for example as low as +100 V, due to an effect of the laser beam 9.

The photoconductive drum 4 with the latent image on the surface is further rotated, and between the region excluding the latent image on the photoconductive drum 4, of which the electric potential is approximately +100 V, and a surface of a developing roller 91, of which the electric potential is approximately +500V, the toner remains closely stuck to the lower-potential region i.e. the surface of the developing roller 91, without being transferred to the region of which the electric potential is approximately +700 V and where no latent image exists. Consequently, the region excluding the latent image is not developed. By contrast, between the latent image region on the surface of the photoconductive drum 4 and the surface of the developing roller 91, the toner performs electrophoresis toward the lower-potential region. That is, the toner adheres to the latent image region on the surface of the photoconductive drum 4. That is how the latent image on the photoconductive drum 4 is developed, to turn into a toner image.

To an intermediate transfer roller 5 that rotates in the clockwise direction, a transfer bias of a reverse polarity to the toner is applied, which is approximately −100 V, so that the toner image developed on the surface of the photoconductive drum 4 is transferred as a primary step to the intermediate transfer roller 5, at the interface between the photoconductive drum 4 and the intermediate transfer roller 5.

The intermediate transfer roller 5 and a secondary transfer roller 6 are disposed so as to oppose to each other across the paper path of the recording sheet 10, and mutually abut at a predetermined nip pressure. The secondary transfer roller 6 rotates in the counterclockwise direction, and is applied voltage of approximately −1 kV. The toner image transferred to the surface of the intermediate transfer roller 5 is transferred to the recording sheet 10 being carried along the paper path at the interface with the secondary transfer roller 6, by the effect of a transfer electric field, the nip pressure and so on, and thus the image is formed on the recording sheet 10. It should be noted that the feeding speed at the developing unit 60 is configured to be faster than the feeding speed of at the feeding unit 50 caused by the feed rollers 2a, 2b.

The secondary transfer roller 6 can be retracted in a position indicated in the dotted line in FIG. 1. When the secondary transfer roller 6 is retracted, the recording sheet 10 is set apart from the intermediate transfer roller 5. With this configuration, when the recording sheet 10 is rewound in the reverse-and-print operation, as the feed roller 2a rotates in the reverse feeding direction, the surface of the intermediate transfer roller can be prevented from being damaged by friction that may otherwise be caused by the recording sheet 10.

The recording sheet 10 that has passed the developing unit 60 is forwarded to the fixing rollers 7a, 7b. The fixing roller 7a is adapted to apply heat to the recording sheet 10, whilst the fixing roller 7b is adapted to apply pressure toward the fixing roller 7a. With these fixing rollers 7a, 7b, the toner image is fixed onto the recording sheet 10. It should be noted that the fixing roller 7b can be retracted in a position indicated in a dashed line in FIG. 1 so that the surface of the fixing roller 7a may not be damaged by friction when the recording sheet 10 is rewound.

The discharged sheet sensor 8 is adapted to detect a predetermined position of the recording sheet 10 with the toner image fixed thereto that passes by the discharged sheet sensor 8 itself. With this configuration, the image forming apparatus 100 can detect an erroneous condition of the recording paper 10. For example, the image forming apparatus 100 can be configured to determine that paper jam has occurred at some point between the fed sheet sensor 3 and the discharged sheet sensor 8, when the recording sheet 10 is not detected by the discharged sheet sensor 8 after a predetermined period of time has passed since the predetermined position of the recording sheet 10 had passed the fed sheet sensor 3.

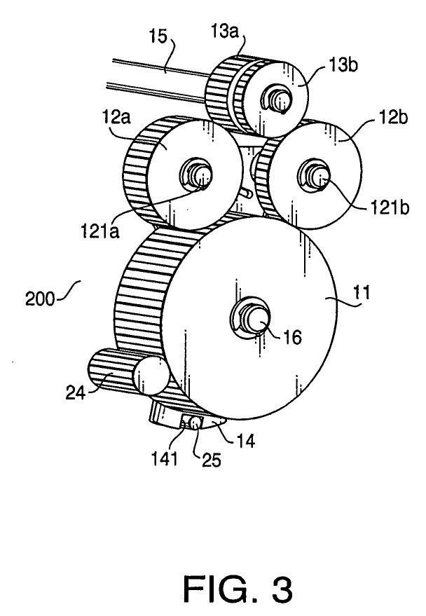

FIG. 2 is a diagram to illustrate the drive direction switching system 200 according to the embodiment of the present invention. FIG. 3 is an enlarged perspective view of the drive direction switching system 200 according to an embodiment of the present invention. FIG. 4 is an enlarged perspective view of the drive direction switching system 200 taken from an opposite side of the side shown in FIG. 2 according to the embodiment of the present invention.

The drive direction switching system 200 is provided with a mechanism to transmit driving force from the drive motor 23 to the feed roller 2a, and is adapted to switch rotating directions of the feed roller 2a. In FIG. 2, the drive direction switching system 200 is arranged at the back of the feed roller 2a. The drive direction switching system 200 includes gears 11, 12a, 12b, 13a, 13b, 24. It should be noted that the gears 11, 12a, 12b, 13a, 13b, 24 are represented in circles, and cog tips of each gear correspond to an outline of each circle shown in FIG. 2.

The gear 11 is engaged with the gear 24 (see FIG. 4) that is coupled to the drive motor 23, and rotates about an axis 16. A lever 14 is adapted to also rotate about the axis 16. The gear 12a is engaged with the gear 11 and is adapted to rotate about an axis 121a, which is fixed to the lever 14. The gear 12b is engaged also with the gear 11 and is adapted to rotate about an axis 121b, which is fixed to the lever 14. The gear 13a is adapted to rotate about a shaft 15, which coincides with the rotation axis of the feed roller 2a. The gear 13b also rotates about the shaft 15. Further, a pin 25 that is in contact with the lever 14 at a recessed portion 141 is provided. The pin 25 is fixed to the body of the image forming apparatus 100 and is adapted to restrict a rotation position of the lever 14.

As shown in FIG. 3, the gear 12a is arranged in a position that is closer in the axial direction to the lever 14 than a position of the gear 12b. It should be noted that, in a cross-sectional view taken along a line that is perpendicular to the axes of the gears 12a, 12b, the gears 12a and 12b are arranged within a depth of the gear 11, wherein depths of the gears 12a, 12b do not overlap each other. Further, the gears 13a, 13b are arranged in positions that correspond to the positions of gears 12a, 12b respectively in the axial direction thereof. When the drive motor 23 (i.e., the gear 24) rotates in the counterclockwise direction in FIG. 4 (correspondingly to a normal drive direction of the drive motor 23), the gear 12a and the gear 13a are adapted to engage each other. When the gear 24 rotates in the clockwise direction in FIG. 4 (correspondingly to a reverse drive direction of the drive motor 23), the gear 12b and the gear 13b are adapted to engage each other. It should be noted that in the present embodiment the gears 12a, 12b are engaged with the gear 11 at all times, however, the gears 12a, 12b are not configured to transmit the drive force to both of the gears 13a, 13b simultaneously.

The gear 13a is provided with a one-way clutch 30 (see FIG. 6) that enables the shaft 15 to rotate independently from the gear 13a when the gear 13a is rotated in the counterclockwise direction in FIG. 2 (i.e., the normal feeding direction). When the recording sheet 10 is forwarded in the normal sheet feeding direction, the drive motor 23 rotates the gear 11 in the counterclockwise direction, the gear 12a in the clockwise direction, and the gear 13a in the counterclockwise direction in FIG. 2. Further, when the recording sheet 10 reaches to the developing unit 60 (a position between the intermediate transfer roller 5 and the secondary transfer roller 6), the recording sheet 10 is carried at a speed that corresponds to a rotation speed developing unit 60, which is faster than the feeding speed of the feeding unit 50 (i.e., the rotating speed of the feed roller 2a). In this state, the feed roller 2a is rotated by the recording sheet 10 being carried in the normal sheet feeding direction. In the present embodiment, when the feed roller 2a is rotated by the recording sheet 10, the rotating force of the feed roller 2a is transmitted to the shaft 15, but the shaft 15 is adapted not to transmit the rotating force from the feed roller 2a to the gear 13a, due to an effect of the one-way clutch 30, and thus the recording sheet 10 is carried at the feeding speed of the developing unit 60. Accordingly, the feed roller 2a is rotated in the equivalent feeding speed of the developing unit 60. It should be noted that the shaft 15 can be rotated by the drive force of the drive motor 23 and by the recording sheet 10 being carried. Therefore, when the feed roller 2a is rotated by the drive force of the drive motor 23, the drive force is transmitted to the shaft 15, and when the feed roller 2a is rotated by the recording sheet 10 being carried, the drive force of the drive motor 23 is not transmitted to the shaft 15. That is, the gear 13a is configured to selectively transmit the rotating force of the drive motor 23 via the one-way clutch 30 to the shaft 15 and not to transmit the rotating force from the drive motor 23 depending on the force applied to the feed roller, whilst the gear 13b without a one-way clutch is configured to compulsorily transmit the rotating force of the drive motor 23 to the shaft 15.

As shown in FIG. 4, the drive direction switching system is provided with a spring 41, which is coupled to the axis 121a of the gear 12a at one end. The other end of the spring 41 is coupled to a spring support member 43, which is fixed to the roll support 21. The spring 41 is thus configured to attract the axis 121a toward the spring support member 43, With this configuration, when the drive motor 23 is activated, the axis 121a is attracted against the attraction force of the spring 41 by the rotating force of the gear 11, which is transmitted to the gear 12a. However, when the drive motor 23 is not activated, the lever 14 is rotated about the axis 16 along with the gears 12a, 12b according to the attraction force of the spring 41 (see FIGS. 2 and 4) in the counterclockwise direction in FIG. 4, and in this position, the gear 12b and the gear 13b are engaged.

In a vicinity to an upper end of the roll support 21, a pulley 44 is provided around the core roll 1, which penetrate through the roll support 21. The pulley 44 is attached to the core roll 1 via the torque limiter (not shown). The pulley 44 is provided with a hook portion 45, to which one end of a spring 42 is hooked. The other end of the spring 42 is hooked to a hook 46 of the roll support 21. When the recording sheet 10 is carried in the normal sheet feeding direction, the pulley 44 is rotated along with the core roll 1 in the normal direction (i.e., the counterclockwise direction in FIG. 4), and thereby pulls the spring 42 upwardly. As the pulley 44 is rotated further, the spring 42 is wound around a circumference of the pulley 44. When the pulley is rotated by approximately 180 degrees, the hook portion 45 of the pulley 44 becomes in contact with a stopper 47 of the roller support 21, and thus the pulley 44 is prevented from being further rotated. Once the rotation of the pulley 44 is stopped by the stopper 47, the core roll 1 rotates independently from the pulley 44 due to an effect of the torque limiter. The torque limiter in the present embodiment is adapted to allow the core roll 1 to rotate independently from the pulley 44 when the torque applied to the torque limiter is greater than approximately 600 g/cm, whilst rotating force required to rotate the pulley 44 against the attraction force of the spring 42 is adapted to be approximately 580 g/cm. Therefore, until the pulley 44 integrally with the core roll 1 is rotated by 180 degrees and is stopped by the stopper 47, and until the torque applied to the torque limiter becomes greater than 600 g/cm, the pulley 44 rotates along with the core roll 1. As mentioned above, the core roll 1 is rotated in the normal direction when the feed roller 2a rotates to forward the recording sheet 10 and thereby pulls the same. When the feed roller 2a stops rotating and stops carrying the recording sheet 10, the core roll 1 also stops being rotated. When the feed roller 2a stops, or when the feed roller 2a rotates in the reverse feeding direction, the spring 42 around the pulley 44 rewinds, and the pulley 44 is pulled by the unwound spring 42 to be rotated in the reverse direction (i.e., the clockwise direction in FIG. 4). In this movement, the core roll 1 is rotated in the reverse direction to unwind the recording sheet 10, which is thus maintained tensioned between the feed rollers 2a, 2b and the core roll 1.

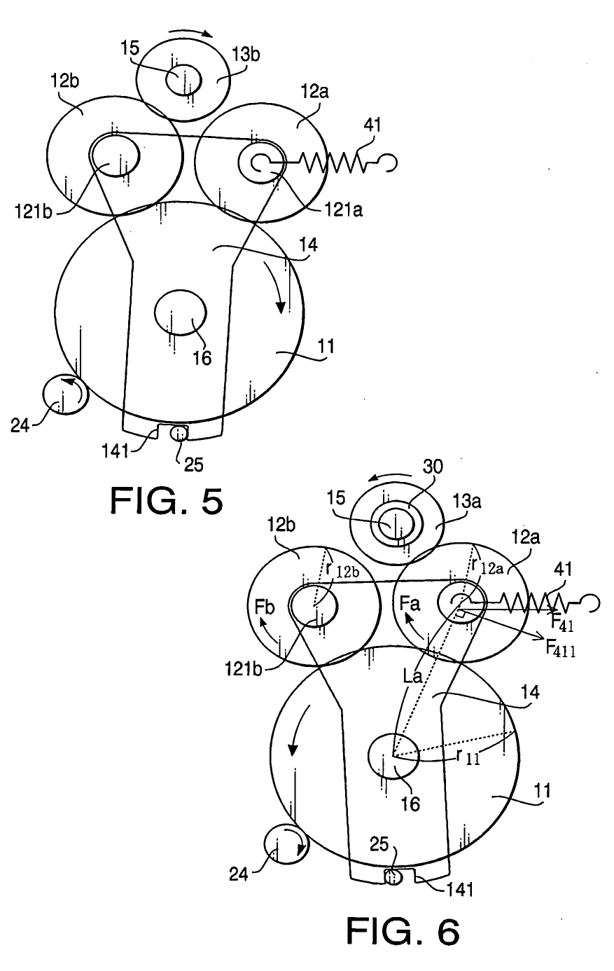

Referring to FIGS. 5 and 6, a mechanism of the drive direction switching system 200 is described hereinbelow. FIG. 5 is a diagram to illustrate a movement of the drive direction switching system 200 according to the embodiment of the present invention. FIG. 6 is a diagram to illustrate another movement of the drive direction switching system 200 according to the embodiment of the present invention. It should be noted that an orientation of the drive direction switching system 200 shown in FIGS. 5 and 6 corresponds to the orientation of the drive direction switching system 200 shown in FIG. 2.

In FIG. 5, the drive direction switching system 200 is in standby state, wherein the image forming apparatus 100 is ready for a printing operation, and the drive motor 23 is not activated (inactive state). FIG. 5 also illustrates the drive direction switching system 200 when the recording sheet 10 is carried in the reverse sheet feeding direction. In FIG. 5, the lever 14 is rotated in the clockwise direction as the spring 41 attracts the axis 121a toward the right-hand side, and the pin 25 rests in the recessed portion 141 with the right-hand side of a circumference thereof in contact with an inner edge of the recessed portion 141. In this position, the gear 12b is engaged with the gear 13b. As mentioned above, the rotation axis of the feed roller 2a is configured to coincide with a rotation axis of the gear 13b, which is engaged with the shaft 15 at all times. Therefore, when the feed roller 2a rotates in the reverse feeding direction, the shaft 15 is required to be rotated along with the feed roller 2a in the counterclockwise direction in FIG. 5. In order to have the shaft 15 rotate along with the feed roller 2a, when the drive motor 23 is in the inactive state, the gears 13b, 12b, 11 must be rotated respectively and the drive motor 23 must be rotated accordingly. It should be noted that the drive motor 23 is a pulse motor, in which external force of a substantial level is required to be rotated. In the present embodiment, the drive motor 23 is incapable of being easily rotated by external force. Therefore, even when the recording sheet 10 is pulled with the external force toward the discharge unit 70 with the drive motor 23 in the inactive state, the feed roller 2a is configured not to be easily rotated. Thus, the drive motor 23 in the inactive state with the feed roller 2a serves as a locking mechanism of the recording sheet 10. When the image forming apparatus 100 is powered and current is supplied to the drive motor 23, holding torque of the drive motor 23 can be generated so that the torque required to rotate the drive motor 23 becomes even greater.

In FIG. 5, when the drive motor rotates in the reverse drive direction (i.e., the counterclockwise direction), the gear 11 rotates in the clockwise direction, which causes the gear 12b to rotate in the counterclockwise direction and the gear 13b in the clockwise direction. Accordingly, the gear 13b rotates the shaft 15, which rotate the feed roller 2a in the reverse feeding direction (i.e., the clockwise direction in FIG. 1). With the rotation of the feed roller 2a in the reverse feeding direction, the recording sheet 10 is carried toward the feeding unit 50. According to this operation, the front end of the recording sheet 10 can be reversed from the discharge unit 70 to a position between the fed sheet sensor 3 and the feed roller 2a.

In FIG. 6, the drive direction switching system 200 is in a sheet feeding operation in the normal sheet feeding direction, wherein the drive motor 23 rotates in the normal drive direction, and the gear 11 is rotated in the counterclockwise direction. It should be noted that the gears 12a, 12b are rotatably supported by the axes 121a, 121b, which respectively generate predetermined amount of frictional force between the gears 12a, 12b when the gears 12a, 12b are rotated. Accordingly, when the gear 11 rotates in the counterclockwise direction, the gear 12a along with the axis 121a and the gear 12b along with the axis 121b are integrally rotated about the axis 16 by the gear 11 in the counterclockwise direction before the gears 12a, 12b are respectively rotated with respect to the axes 121a, 121b. With this movement, torque to rotate the lever 14 in a tangential direction of the pitch circles (i.e., the counterclockwise direction) is generated.

The above-mentioned frictional force will be described hereinafter. The gear 12a is configured to be rotated about the axis 121a independently by torque Fa, and the gear 12b is configured to be rotated about the axis 121b independently by torque Fb. In the present embodiment, a distance between the axis 16 and the axis 121a is represented as a distance La, a radius of a pitch circle when the gear 12a and the gear 11 are engaged is represented as a radius r12a, and a radius of a pitch circle when the gear 12b and the gear 11 are engaged is a radius r12b. Further, the attraction force caused by the spring 41 to attract the lever 14 is F41, whilst a component force to affect F41 in the counterclockwise direction to rotate the lever 14 about the axis 16 is F411. With this configuration, torque to rotate the lever 14 by the spring 41 in the counterclockwise direction is equivalent to La*F411. Further, torque to rotate the lever 14 by the frictional force in the counterclockwise direction is configured to be equivalent to (Fa/r12a)*r11+(Fb/r12b)*r11>La*F411. Accordingly, the lever 14 is rotated about the axis 16. The rotated lever 14 is stopped when the pin 25 becomes in contact with a left-hand inner edge of the recessed portion 141. This is when the rotating force of the gear 11 is transmitted to the gear 13a with the one-way clutch 30 via the gear 12a. In this position, the gear 13a is rotated in the counterclockwise direction. The rotating force of the gear 13a is transmitted to the shaft 15 and thereby rotates the feed roller 2a in the normal feeding direction.

When a printing operation is completed and a portion of the recording sheet 10 with the printed image thereon is discharged, the drive motor 23 rotates in the reverse drive direction until the gear 12a is released from the gear 13a (i.e., the gear 11 is rotated in the clockwise direction as shown in FIG. 5). With this configuration, the above-mentioned locking mechanism of the drive direction switching system 200 for the recording sheet 10 is activated as the rotating force is transmitted from the gear 11 to the gear 13b via the gear 12b when the printing operation is completed, whilst the rotating force is transmitted from the gear 11 to the gear 13a via the gear 12b during the printing operation (i.e., when the recording sheet 10 is carried in the normal sheet feeding direction). It should be noted that the attraction force of the spring 41 to the axis 121a smoothes the activation of the locking mechanism.

It should be noted that the lever 14 may be rotated by other force than the frictional force generated between the gears 12a, 12b and the axes 121a, 121b. For example, the lever 14 may be rotated along with the gear 11 when the lever 14 is configured to generate predetermined amount of frictional force with the gear 11. For another example, the frictional force may not be necessarily used, and an actuator such as a solenoid may be used to switch the gears 12a, 12b to transmit the rotating force of the gear 11 according to the rotation of the gear 11.

As described above, the drive direction switching system 200 in the present embodiment is provided with the intervenient mechanism to transmit the rotating force of the drive motor 23 to the feed roller 2a. The drive direction switching system 200 is further provided with the mechanism to switch the rotating directions of the feed roller 2a according to the rotating direction of the drive motor 23. Furthermore, the drive direction switching system 200 is provided with the locking mechanism to lock the recording sheet 10 by disallowing the feed roller 2a to rotate when the drive motor 23 is in the inactive state (i.e., the standby state of the image forming apparatus 100). It should be noted that a configuration of the drive direction switching system 200 is not limited as described in the present embodiment, as long as the drive direction switching system is provided with above-mentioned mechanisms.

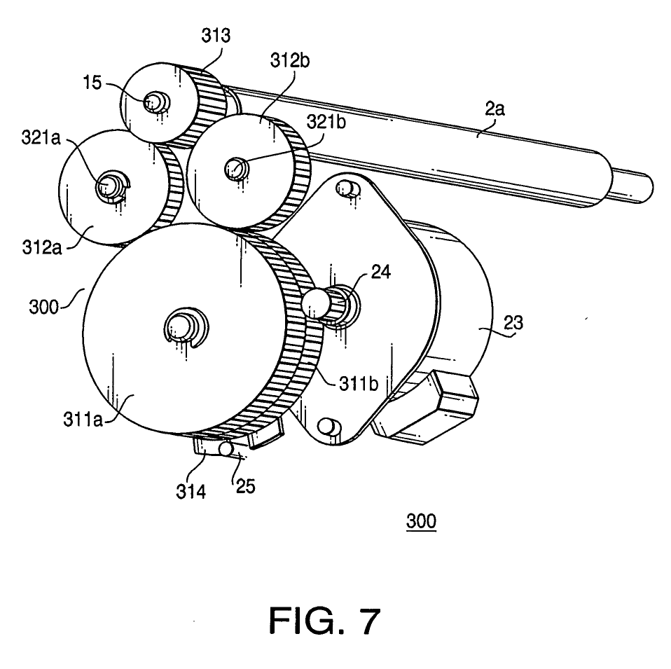

Hereinafter, referring to FIGS. 7-10, a second embodiment of a drive direction switching system 300, which is replaceable with the drive direction switching system 200 in the feeding unit 50 of the image forming apparatus 100, will be described. It should be noted that in FIGS. 7-10, gears 311a, 311b, 312a, 312b, 313, 24 are represented in disks, and cog tips of each gear correspond to an circumference of each disk. In the present embodiment, configurations corresponding to the configuration of the previous embodiment are referred to by the identical reference numerals, and description of those is omitted.

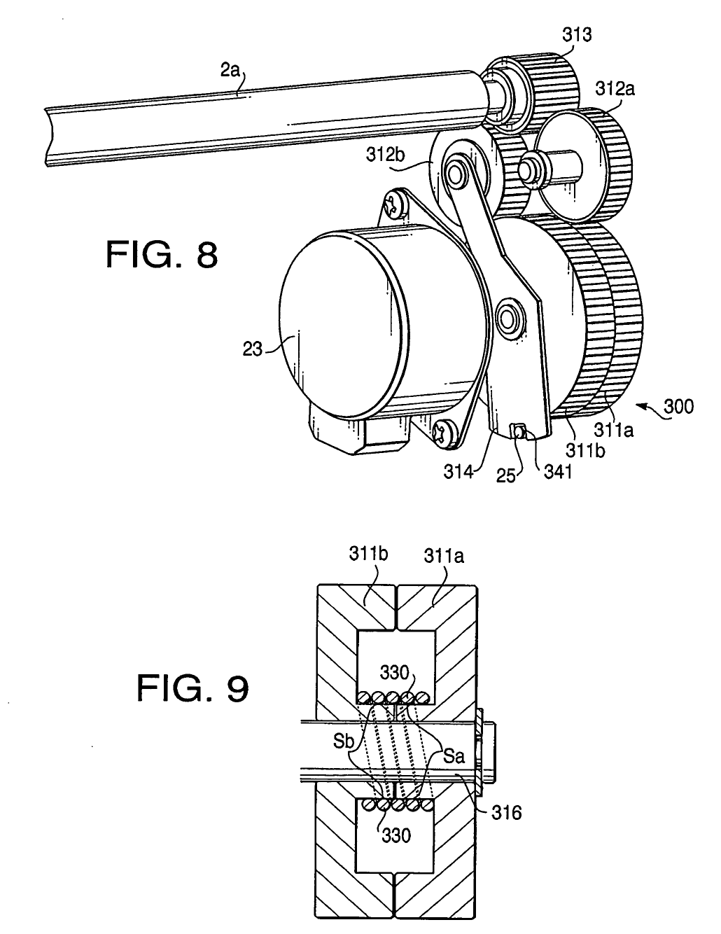

FIG. 7 is an enlarged perspective view of the drive direction switching system 300 according to a second embodiment of the present invention. FIG. 8 is an enlarged perspective view of the drive direction switching system 300 taken from an opposite side of the side shown in FIG. 7 according to the second embodiment of the present invention. FIG. 9 is a cross-sectional partial view of the drive direction switching system 300 according to the second embodiment of the present invention.

As shown in FIG. 7, the drive direction switching system 300 includes gears 311a, 311b, 312a, 312b, 313, and a lever 314. The gear 311a and the gear 311b are arranged in adjacent to each other and are adapted to rotate about a common axis 316. The lever 314 is adapted to rotate also about the axis 316, and is arranged in adjacent to the gear 311b. The gear 311b is engaged with the gear 24 at all times, so that the rotating force of the drive motor 23 is transmitted to the gear 311b via the gear 24. The gear 311a is at all times engaged with the gear 312a, which is engaged with the gear 313 at all times. The gear 312a is not coupled to the lever 314.

The gear 311 is engaged with the gear 312b at all times. An axis 321b of the gear 312b is arranged in a vicinity to a top end of the lever 314. In a vicinity to a lower end of the lever 314, a recessed portion 341 is provided, and the pin 25 is adapted to be in contact with the lever 314 at the recessed portion 341. The pin 25 is fixed to the body of the image forming apparatus 100 and is adapted to restrict a rotation position of the lever 314. The gear 312b is adapted to rotate for a predetermined amount along with the lever 314. The lever 314 is adapted to rotate in the rotating direction of the gear 311b, similarly to the lever 14 rotating in the rotating direction of the gear 12b. It should be noted that the gear 312b is rotated frictional force generated between the gear 312b and the axis 321b. When the gear 311b rotates and the rotating force is transmitted to the gear 312b, but before the gear 312b starts rotating, torque to rotate the lever 314 in a tangential direction of the pitch circles is generated, and the lever 314 is rotated by the gear 312b along with the axis 321b for a predetermined amount. When the pin 25 becomes in contact with the inner edge of the recessed portion 341, the rotation of the lever 314 is stopped thereat, and the lever 314 remains in the position against further rotation of the gear 312b. In the present embodiment, the gear 312b is configured to be rotated between a position wherein the gear 312b is engaged with the gear 313 and a position wherein the gear 312b is released from the gear 313.

FIG. 9 is a cross-sectional partial view of the drive direction switching system 300 according to the second embodiment of the present invention. More specifically, FIG. 9 illustrates a cross-sectional view of the gear 311a and the gear 311b. The gear 311a and the gear 311b are provided with a coil spring 330 therebetween. The gear 311a includes an inner circumferential surface Sa that encircles the axis 316. Similarly, the gear 311b includes an inner circumferential surface Sb that encircles the axis 316. The coil spring 330 is arranged to be coiled around the circumferential surfaces Sa, Sb and is tightly fit to the circumferential surfaces Sa, Sb. One end of the coil spring 330 is fixed to a predetermined position on the circumferential surface Sa, whilst the other end is fixed to a predetermined position on the circumferential surface Sb. Alternately, one end of the coil spring 330 may be fixed to a predetermined position on the circumferential surface Sb, whilst the other end if fixed to a predetermined position on the circumferential surface Sa. An inner diameter of the coil spring 330 in an ordinary state thereof is smaller than outer diameters of the circumferential surfaces Sa, Sb, so that the coil spring 330 is coiled to fit around the circumferential surfaces Sa, Sb with a predetermined tightening force. When the coil spring 330 is installed in the gears 311a, 311b, the coil spring 330 may be untwisted in a direction to expand the inner diameter thereof.

The coil spring 330 is arranged in an orientation so that the coil spring 330 is twisted to tighten the circumferential surfaces Sa, Sb when the drive motor 23 rotates in the normal drive direction and rotates the gear 311b accordingly. As the tightening force applied on the circumferential surfaces Sa, Sb increases, the rotating force of the gear 311b from the gear 24 is transmitted to the gear 311a via the coil spring 330, and the gear 311a rotates integrally with the gear 311b.

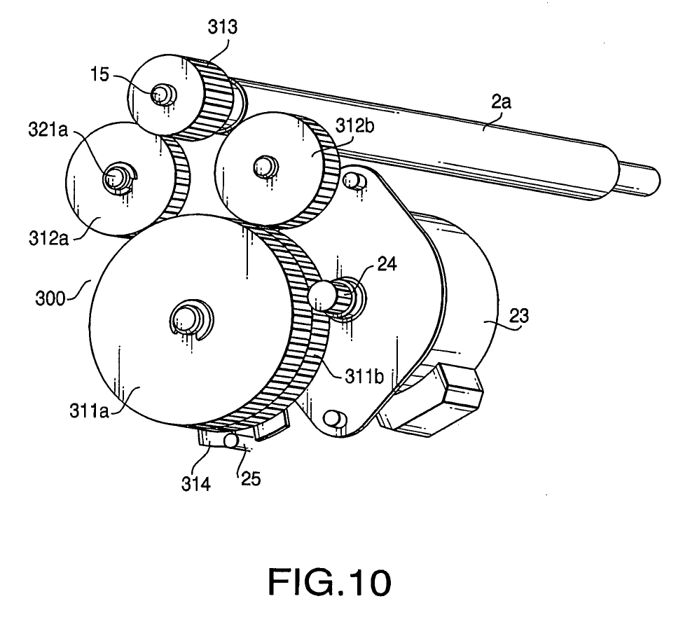

FIG. 10 is an enlarged perspective view of the drive direction switching system 300 with the drive motor 23 rotating in the normal drive direction according to the second embodiment of the present invention. When the drive motor 23 rotates in the normal drive direction, the gear 24 is rotated in the counterclockwise direction in FIG. 10, and the gear 311b is rotated in the clockwise direction accordingly. Further, the lever 314 is rotated in the clockwise direction. Accordingly, the gear 312b is placed in a position wherein the gear 312b is released from the gear 313.

When the gear 311b is rotated for a predetermined amount (i.e., the coil spring 330 is tightened to the twistable extent), the gear 311b rotates integrally with the gear 311a. As the gear 311a rotates, the gear 312a is rotated in the counterclockwise direction. The gear 313, which is in engagement with the gear 312a, but not with the gear 312b, is rotated in the clockwise direction and accordingly rotates the shaft 15 also in the clockwise direction, thus, the feed roller 2a is rotated in the normal feeding direction. In this state, when the feeding speed at the developing unit 60 is faster than the feeding speed at the feeding unit 50 (i.e., the rotation speed of the feed roller 2a), the shaft 15 is rotated in the clockwise direction by the recording sheet 10 being carried by the intermediate transfer roller 5 and the secondary transfer roller 6, and accordingly the gear 313 is rotated in the clockwise direction, the gear 312a in the counterclockwise direction, and the gear 311a in the clockwise direction. When the rotating force from the feed roller 2a is transmitted to the gear 311a as above, the rotation speed of the gear 311a becomes faster than the rotation speed of the gear 311b, although the gears 311a, 311b are rotated in the same (clockwise) direction. In this state, the rotation of the gear 311a loosens the coil spring 330 that has been tightened by the rotation of the gear 311b. The coil spring 330 in the present embodiment is configured to allow the gear 311a to rotate independently from the gear 311b when the coil spring 330 is loosened by the faster rotation of the gear 311a. Therefore, the configuration of the gears 311a, 311b serves as a one-way clutch for the shaft 15. With this configuration as the one-way clutch, the rotating force of the drive motor 23 is indirectly (via the one-way clutch) transmitted to the shaft 15 according to the rotating direction of the drive motor 23. Therefore, in this configuration, the recording sheet 10 can be fed at the feeding speed of the developing unit 60, which is faster than the feeding speed of the feeding unit 50, once the recording sheet 10 reaches the developing unit 60.

Referring to FIG. 7, a locking mechanism of the drive direction switching system 300 will be described. When the drive motor 23 stops rotating in the normal drive direction, the gear 24 and the gear 311b accordingly stop. When the image forming apparatus 100 is in the printing operation, the drive motor 23 is rotated in the reverse drive direction slightly, and when the image forming apparatus 100 is in the reveres-and-print operation, the drive motor 23 is rotated until the front end of the recording sheet 10 is brought back to the position between the feed roller 2a and the fed sheet sensor 3.

When the drive motor 23 rotates in the reverse drive direction, the gear 24 is rotated in the clockwise direction in FIG. 7, and the gear 311b along with the lever 314 is rotated in the counterclockwise direction. Accordingly, the gear 312b becomes in engagement with the gear 313, and the gear 312b starts rotating in the clockwise direction. Accordingly, the gear 313 is rotated in the counterclockwise direction. With the rotation of the gear 313, the shaft 15 is as well rotated in the same direction. Thus, the rotating force of the drive motor 23 is transmitted to the feed roller 2a, which is rotated in the reverse feeding direction, via the gear 311b and the gear 312b. As the gear 312a is engaged with the gear 313 at all times, the gear 312a is rotated in the clockwise direction when the gear 313 rotates in the counterclockwise direction. Accordingly, the gear 311a is rotated in the counterclockwise direction. Therefore, in this state, the gear 311b and the gear 311a rotate at the equivalent rotation speed in the same direction. It should be noted that in the present embodiment a number of the cogs provided to the gear 311a is equal to a number of the cogs provided to the gear 311b. Further, a number of the cogs provided to the gear 312a is equal to a number of the cogs provided to the gear 312b.

When the drive motor 23 rotates in the reverse drive direction for a predetermined amount, the drive motor 23 stops, and the image forming apparatus 100 enters the standby state. In this state, the gear 312b remains engaged with the gear 313. Therefore, the stalling torque of the drive motor 23 is transmitted to the feed roller 2a via the gear 24, the gear 311b, the gear 312b, the gear 313, and the shaft 15 in the same sequence, and the feed roller is locked and disallowed to rotate (a locked state). With this configuration, the recording sheet 10 is prevented from being pulled toward the discharge unit 70 in the standby state of the image forming apparatus 100. When a new printing operation is started (i.e., the drive motor 23 rotates in the normal drive direction), the feed roller 2a is released.

It should be noted in the drive direction switching system 200 of the previous embodiment that the attraction force of the lever 14 and the frictional force generated between the axis 121a and the gear 12a, the axis 121b and the gear 12b must be considered in order to rotate the lever 14 for the predetermined amount when the image forming apparatus 100 is in the printing operation. However, in the drive direction switching system 300 of the present embodiment, the tightening force of the coil spring 330, and other forces to rotate the lever 314 can be considered respectively. Therefore, with the drive direction switching system 300, adjustment of those forces is more easily achieved.

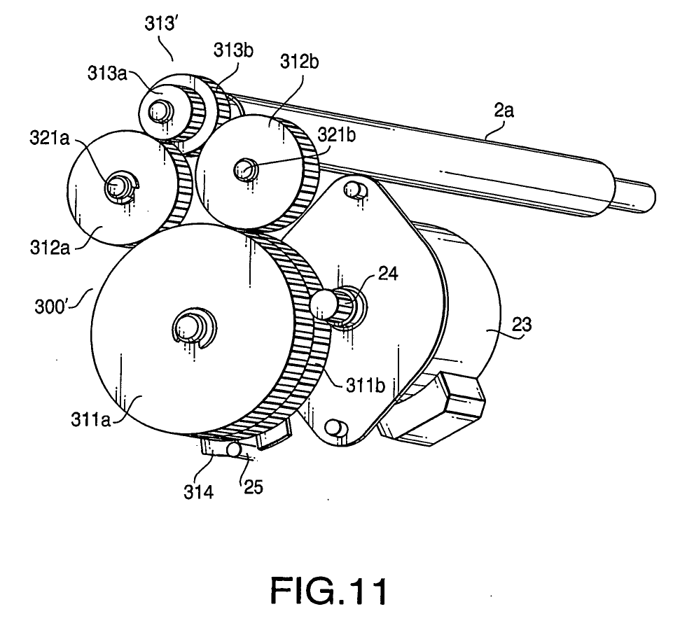

Next, referring to FIG. 11, a mechanism of a drive direction switching system 300′, which is a variation of the drive direction switching system 300, will be described. FIG. 11 is an enlarged perspective view of the drive direction switching system 300′ in the sheet feeding operation according to the variation of the second embodiment of the present invention. In the present embodiment, configurations corresponding to the configuration of the previous embodiment is referred to by the identical reference numerals, and description of those is omitted.

The drive direction switching system 300′ is provided with a gear 313′, which is arranged correspondingly to the gear 313 in the drive direction switching system 300. The gear 313′ includes a smaller diameter portion 313a and a greater diameter portion 313b. The smaller diameter portion 313a is engaged with the gear 312a at all times. The greater diameter portion 313b becomes engaged with the gear 312b when the gear 312b is shifted along the circumference of the gear 311b.

With this configuration, when the drive motor 23 rotates in the reverse drive direction, the gear 313′ is rotated in a counterclockwise direction in FIG. 11 by the rotation of the gear 311b (in the counterclockwise direction) and the gear 312b (in a clockwise direction). Accordingly, the gear 312a (in the clockwise direction) and the gear 311a (in the counterclockwise direction) are respectively rotated. Thus, the gear 311b and the gear 311a are both rotated in the counterclockwise direction. It should be noted that, however, the gear 312a, which is in engagement with the smaller diameter portion 313a, is rotated at a slower rotation speed than the gear 312b, which is in engagement with the greater diameter portion 313b, due to the diameter difference between the smaller diameter portion 313a and the greater diameter portion 313b. As the gear 311a is rotated at a slower rotation speed than a rotation speed of the gear 311b, the tightening force of the coil spring 330 is loosened. It should be noted that the coil spring 330 may be damaged when the coil spring 330 is tightened excessively as the drive motor 23 rotates in the reverse drive direction. Although in the drive direction switching system 300 in the previous embodiment the coil spring 330 may be prevented from being damaged as the rotation speeds of the gear 311a and the gear 311b are substantially equivalent, the damage can be caused by a minor structural errors. Therefore, the above-described configuration of the drive direction switching system 300′ is effective in preventing the coil spring 330 from being damaged, as the drive motor 23 rotates in the reverse drive direction, i.e., the recording sheet 10 is carried in the reverse feeding direction.

Although examples of carrying out the invention have been described, those skilled in the art will appreciate that there are numerous variations and permutations of the image forming apparatus and the drive direction switching system that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

The present disclosure relates to the subject matter contained in Japanese Patent Application No. 2005-137992, filed on May 11, 2005, which is expressly incorporated herein by reference in its entirety.

What is claimed is:

1. A feeding unit for a continuous form recording medium, comprising;
a feed roller, which is adapted to be rotated by one of rotating force and external force to carry the continuous form recording medium;
a drive motor, which is adapted to apply the rotating force to the feed roller;
a first transmitting system, which is adapted to selectively transmit the rotating force from the drive motor to the feed roller according to the force to rotate the feed roller;
a second transmitting system, which is adapted to compulsorily transmit the rotating force from the drive motor to the feed roller; and
a switching system, which is adapted to switch from one of the first transmitting system and the second transmitting system to the other to be used to transmit the rotating force from the drive motor to the feed roller,
wherein the first transmitting system is adapted to transmit the rotating force from the drive motor to the feed roller so that the feed roller is rotated in a normal feeding direction to carry the continuous form recording medium and to allow the feed roller to be rotated in the normal feeding direction by the external force,
wherein the second transmitting system is adapted to transmit the rotating force from the drive motor to the feed roller so that the feed roller is rotated in a reverse feeding direction, and
wherein the switching system transmits stalling torque of the drive motor to the feed roller associated by the second transmitting system before and after the continuous form recording medium is processed through an image forming operation.

2. The feeding unit according to claim 1, comprising;
a first gear, which is fixed to a rotating shaft of the feed roller; and
a second gear, which is adapted to rotate about the rotating shaft of the feed roller via a one-way clutch unit transmitting the rotating force from the drive motor to the feed roller and allowing the rotating shaft of the feed roller to rotate independently from the rotation of the feed roller when the feed roller is rotated by the external force,
wherein the second transmitting system transmits the rotating force from the drive motor to the feed roller by the first gear, and
wherein the first transmitting system transmits the rotating force from the drive motor to the feed roller via the second gear.

3. The feeding unit according to claim 2,
wherein the switching system includes a main transmitting gear, a first intermediate gear, and a second intermediate gear,
wherein the first intermediate gear and the second intermediate gear are respectively engaged with the main transmitting gear,
wherein the main transmitting gear is applied the rotating force by the drive motor,
wherein the first gear is transmitted the rotating force from the drive motor via the first intermediate gear, and
wherein the second gear is transmitted the rotating force from the drive motor via the second intermediate gear.

4. The feeding unit according to claim 3,
wherein the main transmitting gear, the first intermediate gear, and the second intermediate gear are respectively rotatably supported by a supporting member, the supporting member being capable of rotating for a predetermined amount about a rotation axis of the main transmitting gear,
wherein the first intermediate gear and the second intermediate gear are adapted to be respectively shifted for a predetermined amount along a circumference of the main transmitting gear about the rotation axis of the main transmitting gear, and
wherein the switching system is allowed to be in one of a position to have the first intermediate gear engaged with the first gear and a position to have the second intermediate gear engaged with the second gear.

5. The feeding unit according to claim 4, wherein the first intermediate gear and the second intermediate gear are adapted to be shifted along the circumference of the main transmitting gear by rotating force of the main transmitting gear.

6. The feeding unit according to claim 4, wherein the first intermediate gear and the second intermediate gear are adapted to be shifted along the circumference of the main transmitting gear by rotation of the supporting member caused by an attracting member being arranged in a predetermined position of the supporting member.

7. The feeding unit according to claim 1,
wherein the second transmitting system includes a first combination gear and a second combination gear, the first combination gear being operated in combination with the drive motor, the second combination gear being engaged with the first combination gear at all times and being capable of engaging with a fixed gear, the fixed gear being fixed to the feed roller,
wherein the first transmitting system includes a first indirect combination gear and a second indirect combination gear, the first indirect combination gear being configured to rotate integrally with the first combination gear when the first combination gear is rotated for a predetermined amount in a direction corresponding to the normal feeding direction of the feed roller, the second indirect combination gear being engaged with the first indirect combination gear and the fixed gear at all times, and
wherein the first indirect combination gear is allowed to be rotated independently from the first combination gear in the direction corresponding to the normal feeding direction of the feed roller by the external force.

8. The feeding unit according to claim 7,
wherein the switching system includes a supporting switch member rotatably supporting the first combination gear and the second combination gear, the supporting switch member being adapted to rotate about an rotation axis of the first combination gear for a predetermined amount,
wherein the supporting switch member is allowed to be in one of a position to have the second combination gear engaged with the fixed gear and a position to have the second combination gear released from the fixed gear by having the second combination gear to be shifted along a circumference of the first combination gear about the rotation axis of the first combination gear.

9. The feeding unit according to claim 8, wherein the second combination gear is shifted along the circumference of the first combination gear by rotating force of the first combination gear.

10. The feeding unit according to claim 7,
wherein the first combination gear and the first indirect combination gear located in adjacent to each other are adapted to rotate about a common axis,
wherein each of the first combination gear and the first indirect combination gear is provided with an inner circumferential surface that encircles the common axis,
wherein a spring is coiled around the inner circumferential surface of the first combination gear and the inner circumferential surface of the first indirect combination gear, and
wherein the spring is arranged in an orientation so that the spring tightens the inner circumferential surface of the first combination gear and the inner circumferential surface of the first indirect combination gear when the first combination gear is rotated in the direction corresponding to the normal feeding direction of the feed roller.

11. The feeding unit according to claim 7,
wherein the fixed gear is provided with a smaller diameter portion having a diameter and a greater diameter portion having a diameter that is greater than the diameter of the smaller diameter portion, the smaller diameter portion and the greater diameter portion being arranged along a rotation axis of the fixed gear, and
wherein the second indirect combination gear is engaged with the smaller diameter portion and the second combination gear is engaged with the greater diameter portion.

12. An image forming apparatus, comprising;
a feeding unit, which is adapted to guide to carry a continuous form recording medium in a recording media transport path, and
an image forming unit, through which the continuous form recording medium is carried and wherein an image is formed on the continuous form recording medium,
wherein a feeding speed of the continuous form recording medium at the feeding unit is adapted to be lower than a feeding speed of the continuous form recording medium at the image forming unit,
wherein the feeding unit includes a feed roller, which is adapted to be rotated by one of rotating force and external force to carry the continuous form recording medium, a drive motor, which is adapted to apply the rotating force to the feed roller, a first transmitting system, which is adapted to selectively transmit the rotating force from the drive motor to the feed roller according to the force to rotate the feed roller, a second transmitting system, which is adapted to compulsorily transmit the rotating force from the drive motor to the feed roller, and a switching system, which is adapted to switch from one of the first transmitting system and the second transmitting system to the other to be used to transmit the rotating force from the drive motor to the feed roller,
wherein the first transmitting system is adapted to transmit the rotating force from the drive motor to the feed roller so that the feed roller is rotated in a normal feeding direction to carry the continuous form recording medium and to allow the feed roller to be rotated in the normal feeding direction by the external force,
wherein the second transmitting system is adapted to transmit the rotating force from the drive motor to the feed roller so that the feed roller is rotated in a reverse feeding direction, and
wherein the switching system transmits stalling torque of the drive motor to the feed roller associated by the second transmitting system before and after the image forming apparatus is in an image forming operation.

13. A feeding unit for a continuous form recording medium, comprising;
a feed roller, which is adapted to be rotated by one of rotating force and external force to carry the continuous form recording medium;
a drive motor, which is adapted to apply the rotating force to the feed roller;
a first transmitting system, which is adapted to selectively transmit the rotating force from the drive motor to the feed roller according to the force to rotate the feed roller;
a second transmitting system, which is adapted to compulsorily transmit the rotating force from the drive motor to the feed roller; and
a switching system, which is adapted to switch from one of the first transmitting system and the second transmitting system to the other to be used to transmit the rotating force from the drive motor to the feed roller,
wherein the switching system uses the first transmitting system when the feed roller is rotated in a normal feeding direction to carry the continuous form recording medium and uses the second transmitting system when the feed roller is rotated in a reverse feeding direction, and
wherein the feed roller is restricted from rotating by stalling torque of the drive motor before and after the continuous form recording medium is in an image forming operation.

14. The feeding unit according to claim 13,
wherein the first transmitting system is adapted to transmit the rotating force from the drive motor to the feed roller so that the feed roller is rotated in the normal feeding direction to carry the continuous form recording medium and to allow the feed roller to be rotated in the normal feeding direction by the external force.

15. An image forming apparatus, comprising;
a feeding unit, which is adapted to guide to carry a continuous form recording medium in a recording media transport path, and
an image forming unit, through which the continuous form recording medium is carried and wherein an image is formed on the continuous form recording medium,
wherein a feeding speed of the continuous form recording medium at the feeding unit is adapted to be lower than a feeding speed of the continuous form recording medium at the image forming unit,
wherein the feeding unit includes a feed roller, which is adapted to be rotated by one of rotating force and external force to carry the continuous form recording medium, a drive motor, which is adapted to apply the rotating force to the feed roller, a first transmitting system, which is adapted to selectively transmit the rotating force from the drive motor to the feed roller according to the force to rotate the feed roller, a second transmitting system, which is adapted to compulsorily transmit the rotating force from the drive motor to the feed roller; and a switching system, which is adapted to switch from one of the first transmitting system and the second transmitting system to the other to be used to transmit the rotating force from the drive motor to the feed roller,
wherein the switching system uses the first transmitting system when the feed roller is rotated in a normal feeding direction to carry the continuous form recording medium and uses the second transmitting system when the feed roller is rotated in a reverse feeding direction, and
wherein the feed roller is restricted from rotating by stalling torque of the drive motor before and after the image forming apparatus is in an image forming operation.

16. The image forming apparatus according to claim 15,
wherein the first transmitting system is adapted to transmit the rotating force from the drive motor to the feed roller so that the feed roller is rotated in the normal feeding direction to carry the continuous form recording medium and to allow the feed roller to be rotated in the normal feeding direction by the external force.
